(19) United States
(12) Patent Application Publication
(10) Pub. No.: US 2026/0276366 A1
(43) Pub. Date: Sep. 17, 2026

(54) METHOD FOR PROVIDING A FIBER INTERFEROMETER

(71) Applicant: TECHNISCHE UNIVERSITÄT DARMSTADT, Darmstadt (DE)

(72) Inventors: Erik Fitzke, Darmstadt (DE); Oleg Nikiforov, Mainz (DE); Thomas Walther, Riedstadt (DE)

(21) Appl. No.: 19/470,886

(22) PCT Filed: Mar. 26, 2024
(86) PCT No.: PCT/EP2024/058062

§ 371 Date: Sep. 30, 2025

(30) Foreign Application Priority Data
Apr. 5, 2023 (DE) 10 2023 108 782.7

(51) Int. Cl. C03B 37/14; C03B 37/16; G01B 11/02

(52) U.S. Cl. CPC G01B 11/02; C03B 37/16; G02B 6/25

(57) ABSTRACT

A method for providing a fiber interferometer, starting from components, wherein at least one component has a light-guiding fiber with a free end. The method includes manufacturing the fiber interferometer with a preparing of the components based on mechanical cutting of the fiber with the free end, a connecting of the components through fiber connections based on the cut fiber, and with an applying of a static mechanical tension to at least one fiber connection, so as to approximate a length of the at least one fiber connection to a prescribed value and thus provide the fiber interferometer.

### PRIORITY CLAIM

The present application is a National Phase entry of PCT Application No. PCT/EP2024/058062, filed Mar. 26, 2024, which claims priority from German Patent Application No. 10 2023 108 782.7, filed Apr. 5, 2023, the disclosures of which are hereby incorporated by reference herein in their entirety.

### FIELD OF THE INVENTION

The present invention relates to a method for providing a fiber interferometer, to a fiber interferometer, and in particular to a method for manufacturing and adjusting fiber interferometers with a precise arm length difference and phase control through temperature adjustment.

### BACKGROUND

For applications in the field of quantum telecommunication, interferometers are used which guide light or photons in waveguides (in particular glass fibers) and whose arm lengths or optical path lengths, OPL, must be specified with high precision.

FIG. 5 shows, as an example of such an application the basic structure of a system for quantum key distribution (QKD) with phase-time encoding. Shown are a pulse source 10, a generation 20 of entangled photon pairs, as well as three fiber-based interferometers 30, 40, 50 in Mach-Zehnder design with single photon detectors 31, 32, 41, 42, wherein α, β, γ denote phase settings of the interferometers 30, 40, 50. The Mach-Zehnder design serves here merely as an example; other interferometer types, such as Michelson interferometers with Faraday mirrors, can also be used. However, it is important for the application that each interferometer 30, 40, 50 has a relatively large arm length difference, so that the arms can be referred to as “long” and “short” arm. The three interferometers 30, 40, 50 can be located several dozen kilometers apart from each other in different buildings and be at least partially connected with glass fibers. The glass fibers can run for example in the ground or via masts/towers.

With the shown combination of interferometers 30, 40, 50, the so-called two-photon interference according to Franson can be achieved and used for generating quantum keys. This requires that the arm length differences between individual interferometers 30, 40, 50 differ only to a small extent, namely by significantly less than the coherence length of the photons. This means that ideally the long arms of the three interferometers 30, 40, 50 are equally long, and the short arms too. A further requirement consists in keeping the phase in all three interferometers 30, 40, 50 constant relative to each other (e.g. α+β+y=0).

The task of defining the arm lengths or OPL with high precision for all participating interferometers 30, 40, 50 can be divided into two sub-aspects: on the one hand, defining the arm lengths or OPL on length scales significantly larger than the wavelength of light (“macroscopic control”), and on the other hand, defining the change of arm lengths or OPL on length scales smaller than the wavelength of light. The latter primarily serves to control the interferometer phase and is used in particular to achieve high interference contrast.

To achieve accuracies of the OPL in the millimeter range for macroscopic control, geometric measurement of the glass fibers, e.g. with a ruler, is sufficient. Several methods are known for achieving higher accuracies of the macroscopic arm lengths.

One method consists in adapting the fiber lengths in the interferometer arms to the correct lengths by removing material at facets of the glass fiber through polishing. Regular control of the length through white light interferometry/optical coherence tomography (OCT) and the great effort involved in polishing make this method labor-intensive.

Another method consists in manufacturing the interferometers 30, 40, 50 on an integrated optical chip instead of using glass fibers. This method requires complex lithographic technology. Due to the birefringence of the waveguides on the chips, interferometers manufactured in this way are polarization-sensitive. However, for applications in quantum telecommunication such as quantum key distribution, polarization-insensitive interferometers are necessary, which cannot be readily manufactured in this way.

Another method consists in integrating optical delay lines in the interferometer, which are based on coupling the light out of the glass fiber, a variable propagation path in air and coupling the light back into the glass fiber. Due to the coupling out and coupling back of the light, this solution is associated with comparatively high losses of light.

Another method consists in using electronic, mostly electro-optic phase modulators or piezoelectric fiber tensioning devices to change the OPL through mechanical stretching of glass fibers. To enable a sufficiently large adjustment range of the OPL through these devices alone, these stretching devices require a minimum fiber length in the interferometers, which makes the interferometers susceptible to phase disturbances from external temperature influences.

The adjustment of the interferometer phase can be achieved in the prior art through control of an interferometer temperature and the associated change in OPL. In addition, it is known to install additional components for electronic phase control such as electro-optic phase modulators or piezoelectric fiber tensioning devices in the interferometer arms.

In the prior art, it is also known to use methods for stabilizing the interferometer temperature in order to attenuate interferometer phase changes caused by temperature fluctuations during use of the interferometer to such an extent that the phase can be readjusted.

Particularly in quantum technology, this is currently still a young industry in which the products are oriented to the current state of science. Much of this is not yet ready for series production, requires expensive components or is very labor-intensive in the manufacture and adjustment of interferometers.

Here and in the following, manufacture of an interferometer shall be understood as its assembly from components up to macroscopic control, i.e. defining the arm lengths or OPL on length scales larger than the wavelength of light.

Furthermore, here and in the following, adjustment of the interferometer shall be understood as defining the OPL on length scales smaller than the wavelength of light. The adjustment of the interferometer phase can comprise fine adjustment of an optical path length of the interferometer and/or control of an interferometer phase. The adjustment of the interferometer usually follows the manufacture.

In addition, here and in the following, provision of an interferometer shall be understood as at least its manufacture, but optionally also its adjustment.

There is a need for cost-effective and efficient solutions for manufacturing interferometers that are as precisely identical as possible and for adjusting their interferometer phase.

### SUMMARY OF THE INVENTION

This purpose is at least partially achieved by a method for providing a fiber interferometer according to claim 1 and by a fiber interferometer according to claim 13. The dependent claims relate to advantageous realizations of the subjects of the independent claims.

The present invention relates to a method for providing a fiber interferometer, or fiber-based interferometer, based on components that are each configured to be connected to one another via fiber connections. The fiber interferometer can in particular be a Michelson interferometer or a Mach-Zehnder interferometer. At least one of the components has a light-guiding fiber, in particular such as a glass fiber, which has a free end at a starting point of the method. The method comprises manufacturing the fiber interferometer. Manufacturing the fiber interferometer comprises preparing the components based on mechanical cutting of the fiber with the free end, connecting the components through fiber connections based on the previously cut fiber, and applying a static mechanical tension to the at least one fiber connection, so as to approximate a length of the at least one fiber connection to a prescribed value and thus manufacture the fiber interferometer.

The method can in particular start from prefabricated optical components. The components may include, for example, a mirror, a fiber coupler or a beam splitter. Further components can be, for example, pure sections of fibers. A Mach-Zehnder interferometer can in embodiments be constructed from two beam splitters and does not have to comprise mirror components.

The components can each have a component housing in which a mirror, fiber coupler or partial reflector is correspondingly enclosed. The light-guiding fibers can in particular be glass fibers that are configured to guide light or photons into the interior of the component housing and/or out of the interior of the component housing. The light-guiding fiber is thus not or not completely enclosed by the component housing. The light-guiding fiber on the respective component is usually surrounded by a coating, for example a polymer coating. The polymer coating can enclose several fibers or fiber strands.

The fibers and components can be configured to preferentially guide light or photons of a certain polarization, or to suppress further guiding of light or photons of a certain polarization. Furthermore, the fibers and/or components can be configured as polarization-maintaining fibers or components.

Advantageously, the preparing of the components comprises, apart from the mechanical cutting, no further adaptation of a length of the respective fiber, thus in particular no polishing or tempering of the fiber. In embodiments, it can be provided to define lengths of the light-guiding fibers to a tolerance of about 100 μm through the preparing of the components.

The connecting of the components can be carried out in the framework of joining the components together. This can comprise fixing the component housings in a relative position and lead at least to a preliminary alignment of the first and second fiber. The fiber connections can be produced from fibers contained in the components. In particular, the previously cut free end of the fiber of the at least one component can be connected with another end of a fiber of a further component. The other end or the fiber of the further component can also have been mechanically cut previously.

In embodiments, at least two components are present, each having a fiber with a free end. At least one of them is precisely cut in the method. The two free ends of the fibers of the components can subsequently be connected by splicing, so that the optical path length of a resulting fiber connection can be defined to approximately 100 μm accuracy. Further components of the interferometer do not necessarily have to have fibers with free ends. Such components can also be connected, for example, by plug connections.

The term connecting is to be understood broadly. In particular, it does not have to refer to establishing a permanent connection; rather, the components can be connected or joined together in a preliminary manner.

In embodiments, lengths of the fiber connections can be defined to a tolerance of 100 μm through the connecting. This can apply in particular to the length of the at least one fiber connection. The at least one fiber connection can be based on the previously cut fiber of the at least one component. In particular, the at least one fiber connection can arise from connecting previously cut free ends of fibers. Not all fiber connections have to be based on fibers with free ends.

The applying of static mechanical tension to the at least one fiber connection utilizes an optomechanical effect, according to which both a spatial length of the at least one fiber connection and a refractive index in the fiber can change as a result of the tension. Both together affect the optical path length. The term length of the at least one fiber connection, and generally the lengths of the fiber connections, can indeed also refer to purely spatial dimensions, but advantageously the term concerns an optical path length of the respective fiber connection. The prescribed value can in particular be a suitable target value for the length. By applying the static mechanical tension to the at least one fiber connection, the length as an optical path length of the at least one fiber connection can be defined to a tolerance of about 10 μm to the prescribed value.

Optionally, the method comprises adjusting the interferometer. For this purpose, the interferometer can have a controllable device for adjustment, in particular for fine adjustment and/or for control of the interferometer phase, after manufacturing. The controllable device can be, for example, an electro-optic phase modulator or a piezoelectric or electromechanical fiber stretcher. The controllable device can be contained in one of the components.

Optionally, the adjusting of the interferometer phase comprises tempering the at least one fiber connection, so as to further approximate the length to the prescribed value.

In further embodiments, at least one fiber connection is thus actively tempered, i.e. brought to a temperature, so that it or its length grows or decreases to the prescribed value.

The tempering utilizes a thermo-optic effect, according to which the optical path length, in particular both the spatial length of the corresponding fiber and the refractive index, can change due to a temperature change. The change in optical path length is reversible. The tempering can thus in particular be performed to achieve a microscopic length change in the range of less than one wavelength for adjusting the interferometer phase. The at least one fiber connection, and possibly several or all fiber connections, can initially be exposed to target temperatures T that cause changes in the corresponding lengths by values greater than a typical wavelength of the light or photons. Small temperature changes ΔT in the vicinity of T that act on the fiber connections can furthermore be used to adjust the optical path lengths of the corresponding fibers to a tolerance of significantly less than 0.1 μm and thereby control the interferometer phase. The optimal temperature of the fibers is then given by T+ΔT. As the utilized thermo-optic effect is reversible, a different optical path length difference can be set by changing T at a later time and/or a different interferometer phase can be set by changing ΔT.

In embodiments, the applying of static mechanical tension can be combined with the tempering. For example, the tension can be applied while simultaneously changing the temperature, or the two steps can be repeated individually or together iteratively. Between the repetitions, in particular an examination or control of the length of the fiber connections can take place. The method can also be combined with further techniques for controlling the optical path length and phase. In particular, further adjustment devices for the phase or electronic fiber stretchers can additionally be installed in the interferometer.

In further embodiments of this method, a combination of precise mechanical preparation of the glass fibers used, the optomechanical and thermo-optic effect can therefore be used. Through mechanical preparation, accuracies of the path length difference of approximately 100 μm are achieved, through the optomechanical effect accuracies up to approximately 10 μm, and through the thermo-optic effect accuracies of up to below 0.1 μm. The static mechanical tension applied to the glass fibers in combination with active temperature adjustment allows control of the phase in the interferometer with a precisely set path length difference. Optionally, however, the adjusting of the interferometer takes place exclusively through tempering. Advantageously, no other technique for defining the optical path length is necessary in the method during or after applying the static mechanical tension and tempering to adjust the fiber interferometer in optical path length and phase. It has been found in particular that adjusting the interferometer phase can advantageously be based solely on changing the temperature; Thus in particular no further application of mechanical tension needs to be provided.

Optionally, the preparing of the components comprises fixing the at least one component with the fiber with the free end in a holding device, pretensioning the fiber by applying a tensile force to the free end of the fiber, and clamping the fiber by a clamping device, so as to enable the mechanical cutting of the fiber.

Optionally, the at least one component comprising the fiber with free end has a component housing, and the fixing of the at least one component comprises inserting the component housing into the holding device, so as to enable the mechanical cutting of the fiber at a predetermined distance from the component housing. The component housing can be inserted into a recess or cutout of the holding device designed for this purpose.

Alternatively or additionally, the fixing of the at least one component can also comprise clamping the fiber with the free end in a mounting fixture, wherein the mounting fixture is then inserted into the holding device. The at least one component comprising a fiber with free end does not necessarily have to have a component housing; it can merely be a fiber section. The mounting fixture is to be distinguished from a fiber tensioning device. The mounting fixture can be designed as a simple fiber holder.

The holding device can thus be configured to fix the at least one component via a component housing, or to fix the at least one component via the mounting fixture holding the fiber. This can be achieved, for example, by a suitable recess or cutout in the holding device into which the component housing or the mounting fixture can be inserted.

Optionally, the applying of the static mechanical tension (tensile stress) is based on a mechanical, an electromechanical or a piezoelectric fiber tensioning device. The fiber tensioning device can be provided as a further component or as part of a further component and can already be integrated into the structure of the fiber interferometer when joining the components together. The fiber tensioning device or the component of the fiber interferometer comprising the fiber tensioning device can in particular comprise a fiber with two loose ends. In other embodiments, however, the fiber tensioning device can also merely be used to apply the static mechanical tension to a fiber of a component or to a fiber connection. The fiber tensioning device can thus also be integrated into the fiber interferometer to be provided after connecting the components.

Optionally, the applying of the static mechanical tension is based on a fiber tensioning device having a winding body configured to wind the at least one fiber connection around the winding body, and having an adjustment device configured to change a diameter of the winding body and thus apply the tension.

Optionally, the fiber interferometer to be manufactured has a tempering device configured to perform the tempering based on the tempering device by changing a temperature.

The thermo-optic effect can be used for macroscopic control and in particular also for adjusting the interferometer, i.e. for fine adjustment and/or for control of the interferometer phase. This is particularly advantageous when the same tempering device can be used for both uses or applications, which can in particular be permanently connected to the actual interferometer or integrated into the fiber interferometer. It should be noted that macroscopic control of the lengths of the fiber connections requires temperatures or temperature differences T that can be several orders of magnitude larger compared to a temperature change ΔT needed for adjusting an interferometer phase. For example, the macroscopic control of the length can be performed by setting the temperature T in the range of a few degrees Celsius around room temperature, while ΔT is set in the range of millidegrees Celsius.

Optionally, in particular the tempering for adjustment of the interferometer comprises changing a temperature within a housing or tempering housing that encloses the at least one fiber connection.

The housing can be part of the tempering device of the fiber interferometer and in advantageous embodiments can also completely enclose the latter. The interferometer usually has two arms (for two different paths of light), and in embodiments it has proven advantageous to arrange both arms in the housing or in a controlled environment. In embodiments, it has also proven advantageous to be able to set a temperature to approximately 0.5 mK accuracy through the temperature (control) device.

Optionally, the method comprises providing a reference interferometer and measuring the length of the at least one fiber connection based on a comparison with the reference interferometer.

The connecting of the components, the applying of the mechanical tension and the tempering can each take place over several stages or iterations, between each of which the measuring can be performed.

In particular, when joining the components, component housings can initially only be loosely or easily detachably fixed and the cut ends of the fibers can only be loosely or easily separably connected. Then an examination or control and if necessary a correction of the length of the fiber connections can take place through said measuring and if necessary a correction, before assembly of the components is completed and the components are firmly connected.

Likewise, the applying of tension and/or the tempering can each take place in a suitable alternation with an examination or control and if necessary, a correction, wherein said measuring and comparison with the reference interferometer is performed.

Optionally, the measuring is based on white light interferometry and/or on optical coherence tomography. Both methods are known in the prior art for the purpose of comparing different interferometers and can advantageously be used here for examination or control and if necessary, correction for defining the length of the fiber connections.

Embodiments also relate to a fiber interferometer manufactured from components connected by fiber connections. The fiber interferometer comprises a fiber tensioning device having a winding body around which at least one fiber connection is wound, and having a fiber tensioning device configured to change a diameter of the winding body and thus apply mechanical tension to the at least one fiber connection. The fiber interferometer also comprises a tempering device configured to perform tempering of the fiber connections based on the tempering device by changing a temperature. The tempering device can also be configured to effect, in addition to macroscopic control of the lengths of the fiber connections, an adjustment of the interferometer, in particular to control an interferometer phase.

Important aspects of the presented method and the presented fiber interferometer can also be presented as follows.

The method combines several techniques and effects to enable construction and operation of interferometers that are as identical as possible with nearly identical path length differences between the arms of each interferometer using conventional glass fiber-based components for optical communication technology. In embodiments, length differences of the glass fibers to be installed, which arose during manufacture of the components, are first measured and corrected by mechanical cutting. The components are connected, and remaining inaccuracies are compensated by mechanical stretching of the glass fibers without the life expectancy of the glass fibers suffering. Adjustment, such as further fine adjustment, takes place reversibly through temperature adjustment. A central aspect of the method consists in exploiting the combination of the optomechanical and thermo-optic effect in the glass fibers to change spatial length and refractive index or the optical path length of the fibers and thereby match the optical path lengths to one another.

The thermo-optic effect can be further used to perform control of the interferometer phase. Generally, the temperature range for the phase change in the fiber interferometer is several orders of magnitude smaller than the temperature range needed to compensate for residual errors.

In embodiments, the method can be structured, for example, by the following steps:
Matching the fiber lengths on at least one of the interferometer components (accuracy in the millimeter range), embodiments comprise at least two components each with a free end to establish a connection between them by splicing, wherein at least one of the two components is matched in fiber length by mechanical cutting;
Preparing the components by precisely measuring the fiber lengths on the components and correcting length deviations using a specially developed mechanical holding device for precise mechanical cutting of defined glass fiber lengths (accuracy approx. 100 μm);
Joining the parts to form an interferometer and subsequent mounting on a mechanical fiber tensioning device;
Measuring the deviation in optical path length and adjustment by applying mechanical tension (accuracy a few 10 μm); and
Further fine adjustment of the optical path length through tempering, i.e. adjustment of the interferometer temperature (accuracy better than 0.1 μm).

The interferometer phase can also be adjusted by adjusting the interferometer temperature.

An important aspect of the method is that in embodiments for providing the fiber interferometer, concrete values are needed neither for the temperature of the interferometer nor for the mechanical tension or need to be numerically known. Rather, a known interferometer state, given by a fixed value of the optical path difference, can be specified and then mechanical tension and temperature can be optimized to achieve this state. The exact numerical values for mechanical tension and temperature are irrelevant. In embodiments, the mechanical tension or a length change caused by it does not need to be known at all, and the temperature can be controlled to a target value via an uncalibrated sensor. This aspect also distinguishes the presented method from calibrating an interferometer for measurement purposes, in which known temperature, tension or load values are specified and set in order to then calibrate a state of the interferometer via the resulting interference pattern. Rather, the presented method can achieve an adjustment of a predetermined interferometer state defined by the path difference that is important for the quantum optical application.

Another important aspect of preparing the components lies in a specially developed holding device for precise mechanical cutting of the lengths of glass fiber and the glass fibers on optical components.

Another important aspect consists in the compensation of the differences in optical path length through a combination of optomechanical and thermo-optic effect. This includes static mechanical tensioning of the glass fiber and adjustment of the temperature.

Another important aspect is that fine adjustment of the optical path length with phase stabilization and adjustment can take place solely based on control and adjustment of the interferometer temperature.

Another important aspect is that for examination, control and if necessary correction of the optical path length during the method, a known method of white light interferometry and/or optical coherence tomography in the frequency range of light or photons can be used. This method can also be used with optical components with non-negligible chromatic dispersion.

Another important aspect is that preparing the components for mechanical cutting of the fibers can comprise fixing the relevant component in a holding device, pre-tensioning the fiber by applying a tensile force to the free end of the fiber and clamping the fiber by a clamping device, so as to enable mechanical cutting of the fiber, for example at a predetermined distance from a component housing.

Another important aspect is that a purely mechanical pre-tensioning device can be used for applying the mechanical tension, in particular thus no piezo-controlled fiber tensioning devices need to be used.

Another important aspect is that adjusting the interferometer phase can be based solely on changing a temperature, without having to apply mechanical tension for this purpose as well.

Embodiments of the present invention offer, among others, the following advantages.

The presented method enables simple, precise and reproducible construction of fiber optic interferometers or fiber interferometers and the adjustment of their optical path length (OPL). For applications such as quantum key distribution, the interferometer arms for these fiber interferometers must be manufactured with high precision in the range of a few micrometers. In addition, the interferometer phase must be controlled to achieve high interference contrast. The presented method allows the OPL of the components needed for construction to be precisely measured and to compensate for deviations that are potentially still present after completion of assembly. The presented method then makes it possible to define the OPL through temperature changes down to the sub-micrometer range and thus control the interferometer phase.

The presented method makes it possible to reduce manufacturing costs and time requirements for the construction of fiber interferometers with precisely matched path length difference. Alignment with a reference interferometer enables faster production of larger quantities of such fiber interferometers at low cost.

Since neither a piezo fiber stretcher nor a phase modulator (e.g. based on the electro-optic effect) is needed for fine adjustment and control of the phase, the complexity of the fiber interferometer is reduced, which lowers costs during construction and susceptibility to errors during operation. Alternatively, by using the method in combination with piezo fiber stretchers or phase modulators, the necessary adjustment range of these components can be reduced, so that their application is simplified or cheaper components can be used. An example is reducing the necessary minimum fiber length for piezoelectric fiber stretchers, which leads to increased stability of the interferometer against temperature fluctuations.

### BRIEF DESCRIPTION OF THE DRAWINGS

The embodiments of the present invention will be better understood from the following detailed description and the accompanying drawings of the different embodiments, which however should not be understood to limit the disclosure to the specific embodiments, but merely serve for explanation and understanding.

FIG. 1 illustrates an embodiment of the presented method for manufacturing a fiber interferometer.

FIG. 2 illustrates steps of an embodiment for preparing components.

FIG. 3 shows a fiber tensioning device for applying mechanical tension to a fiber.

FIG. 4 shows an embodiment of the presented fiber interferometer.

FIG. 5 shows a conventional system for quantum key exchange.

### DETAILED DESCRIPTION

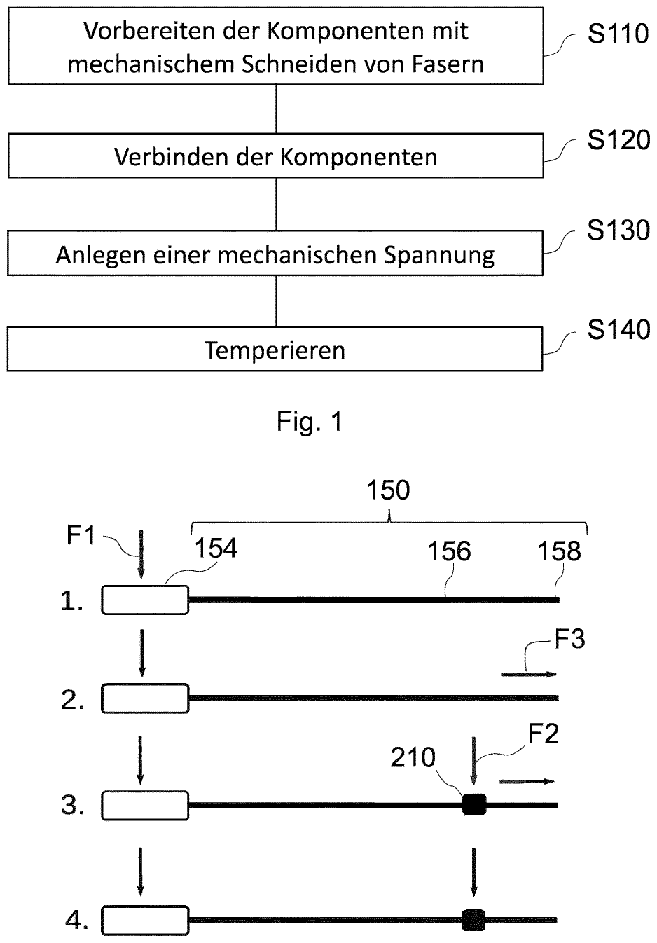

FIG. 1 illustrates an embodiment of the presented method for manufacturing a fiber interferometer. A starting point of the method comprises provided optical components, such as mirror components and in particular Faraday mirrors, beam splitter components and light-guiding fibers. A fiber tensioning device can be present, which is built into the fiber interferometer. At least one component has a light-guiding fiber with a free end for connection with other components. In the method, further devices, in particular a tempering device, can also be integrated into the fiber interferometer.

The method comprises for manufacturing the interferometer a preparing S110 of the components by mechanical cutting of the fibers, a connecting S120 of the components through fiber connections that can arise by connecting the free ends of the fibers, as well as an applying S130 of static mechanical tension to at least one fiber connection, so as to approximate a length of the fiber connection to a prescribed value and thus manufacture the fiber interferometer. In the presently shown embodiment, the method also comprises an adjusting of the interferometer, which comprises a tempering S140 of the at least one fiber connection, so as to approximate the length of the at least one fiber connection to a prescribed value and thus overall provide the fiber interferometer.

The method can in particular also comprise providing a reference interferometer as well as at various points, in particular during the applying S130 of mechanical tension, but also during the tempering S140, measuring path length differences between the interferometer to be provided and a reference interferometer. In this way, the interferometer can be manufactured and/or provided precisely identically to the reference interferometer.

Embodiments of the method are characterized by a combination of a simplified setup for Michelson interferometers and a method for their manufacture. Both allow uncomplicated manufacture of Franson interferometers for two-photon interference and provide a solution for efficient manufacture of interferometers that are as precisely identical as possible as well as for adjusting the interferometer phase. In the method, the components, i.e. the individual optical interferometer constituents, are prepared by precisely and simply mechanically cutting the corresponding fibers. Later, the remaining deviations of the optical path length of fiber connections are eliminated through a combination of optomechanical and thermo-optic effects. The phase of the fiber interferometers can also be controlled through the thermo-optic effect, which can lead to a significant complexity reduction of the setup.

The optomechanical or thermo-optic effect describe changes in the refractive index of the glass fiber depending on the applied mechanical tension or temperature. The static mechanical stretching is applied to the fiber to adjust the length with an accuracy on the order of approximately 10 μm. The fine adjustment of the OPL and interferometer phase takes place through temperature changes and corresponds to length change on the order of less than 10 μm. The adjustment of the phase requires a length change on the order of less than 0.1 μm.

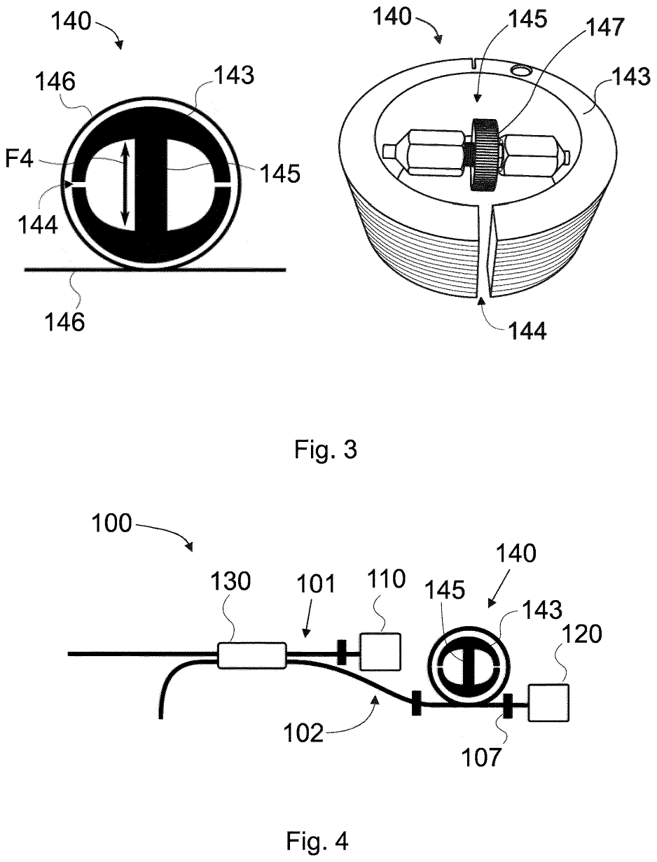

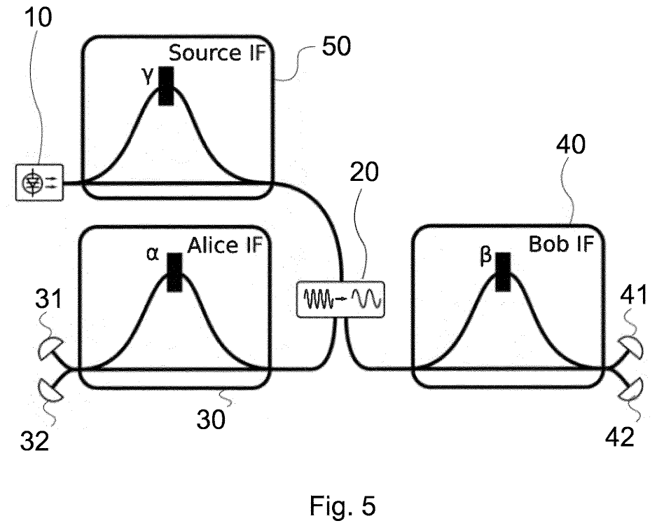

An embodiment of the method characterized by the following steps has proven to be particularly advantageous:
Construction of a reference interferometer, relative to which the fiber interferometer to be manufactured or all other fiber interferometers to be manufactured are aligned;
Precise cutting of the fiber lengths on the components or parts through a mechanical device, as described with reference to FIG. 2;
Joining these components to form a temporary interferometer without firmly connecting the parts;
Measuring differences between the temporary interferometer and the reference interferometer using so-called white light interferometry/optical coherence tomography (OCT) in the frequency domain;
Repeated cutting of the fiber lengths of certain components with correction of the measured deviations;
Firm joining S120 of the components and subsequent mounting on a mechanical fiber tensioning device;
Measuring the difference of the joined interferometers to the reference interferometer with white light interferometry/OCT;
Coarse adjustment of a path length difference by applying S130 or adjusting a static mechanical tension of the glass fiber in one of the arms of the fiber interferometer, based on a fiber tensioning device as described in FIG. 3 and based on the results from the previously mentioned step. By alternately repeating this step and the previously mentioned step, the path length difference of the interferometers is minimized;
Fine adjustment of the path length of the fiber interferometer through tempering S140 or adjustment of the temperature of the fiber interferometer.

FIG. 2 schematically illustrates steps of an advantageous embodiment for precise mechanical cutting of the glass fiber-coupled components.

Shown is a component 150, specifically a glass fiber component (for example with a Faraday mirror or a beam splitter), which is partially enclosed in a component housing 154. The light-guiding fiber 156 to be precisely cut, here in particular a glass fiber, runs out of the component housing 154. This has a free end 158.

For simplicity, only one glass fiber 156 is shown; however, the embodiment can also be performed for components with one or more incoming and outgoing light-guiding fibers of other types by performing the steps illustrated here for all fibers individually and sequentially.

Also shown is a clamping device 210 or a fiber holder for the fiber 156, relative to which the fiber 156 is reproducibly separated during mechanical cutting or cleaving, for example with a commercial fiber cleaver.

Before the cutting process, the end of the glass fiber 156 usually must be freed from a polymer coating and the required length of the glass fiber 156 must be determined.

The steps described below are illustrated in the figure correspondingly numbered in a sequence from top to bottom. Arrows F1, F2, F3 indicate in which direction a force should be applied during the process. Arrows F1, F2 downward mean the fixing of a component, arrows F3 to the right the tensioning of the glass fiber 156. The steps comprise:
1. Attaching the component housing 154 on a holding device, such as a prepared base like a metal plate with a suitable recess or cutout for the component housing 154. This ensures that the component housings 154 of different components 150 of the same type are reproducibly attached at one location. The component housing 154 is inserted into the cutout and secured against displacement and tilting, and for this purpose e.g. screwed or clamped. If the glass fiber component 150 is a loose glass fiber without component housing, one end of the fiber can be clamped in a fiber holder and this fiber holder can be used in the described process instead of the fiber component (not shown).
2. Pre-tensioning the glass fiber 156 with a reproducible force F3. A possible implementation for this step is based, for example, on a pulling device with a weight attached to the glass fiber 156, so that the reproducible force F3 is applied by a weight force. Other methods for reproducibly applying the force F3 can also be used.
3. Attaching the clamping device 210 or a fiber holder that is used during splicing. The clamping device 210 can be part of the holding device and is advantageously positionable at a fixed, finely adjustable distance from the attachment of the component housing 154 to ensure mechanical cutting or cleaving of the fiber 156 at a reproducible length. This allows small, defined differences in fiber length to be compensated or created, as needed e.g. for compensating length variations of the glass fiber 156. In embodiments, it has proven particularly advantageous to set up a mechanical micrometer displacement unit (not shown) with which the clamping device 210 can be precisely positioned. The micrometer displacement unit can be attached to the prepared base and be part of the holding device. The clamping device 210 can be detachably connected to the micrometer displacement unit.
4. Releasing the tensile stress on the fiber 156 and releasing the attachment of the clamping device 210. The clamping device 210 can then be taken from the micrometer displacement unit or from the prepared base and the fiber 156 can be mechanically cut with a cleaver at a length now precisely designated by the clamping device 210 (not shown). This cleaving creates fiber ends with a very precisely reproducible length relative to the clamping device 210 with most known cleaver machines. After a cleave process, the component 150 can be measured or also directly installed.

FIG. 3 shows on the left a schematic and on the right a perspective representation of a particularly advantageous fiber tensioning device 140, as can be used for applying S130 the mechanical tension.

In the schematic representation on the left in the figure, the fiber tensioning device 140 comprises a winding body 143 around which a fiber 146 is wound, and an adjustment device 145 configured to change a diameter of the winding body 143 by exerting a force F4 spreading the winding body 143 and thus determine a tension in the glass fiber 146. So that the winding body 143 can be spread, it has an opening or gap 144.

After precisely cutting the fibers 156 and joining the components 150, 140 together, remaining fiber length differences can be further reduced with the mechanical fiber tensioning device 140 by stretching the fiber 146. Tensioning the fiber 146 leads to a change in OPL through a geometric length change and a tension-induced change in the refractive index of the fiber 146 (optomechanical effect).

Overall, small fiber length differences that arise during cutting can be compensated again through the mechanical tension. In this way, in particular the length or optical path length of the at least one fiber connection wound around the fiber tensioning device 140 can be approximated to the corresponding prescribed value.

The fiber tensioning device 140 can initially be present as a component itself in the method and comprise a fiber with one or two free ends. The relevant fiber can be mechanically cut during preparing S110. In advantageous embodiments, however, the fiber tensioning device 140 itself does not need to have a fiber and can only be integrated into the fiber interferometer 100 during or after connecting S120 the components. For example, a fiber of a component can be so long that it is wound around the winding body 143 of the fiber tensioning device 140 on the one hand and then its free end is spliced to a free end of a fiber of another component. This can be advantageous since splice points can be saved this way.

An advantageous technical implementation of the fiber tensioning device 140 is shown in the right part of the figure. The fiber tensioning device 140 comprises a ring made of copper or brass as winding body 143, which is half-open and can be spread from the inside by a screw in an adjustment device 145. The material can advantageously be chosen so that the thermal conductivity of the ring 143 is as high as possible. A lock screw 147 secures the spreading. The glass fiber 146 can be wound around the outside of the ring 143 in grooves specially provided for this purpose and attached at points opposite the opening 144 of the ring 143 with adhesive.

FIG. 4 shows an embodiment of a fiber interferometer 100 as can be manufactured with the presented method. The structure is that of a Michelson interferometer. The fiber interferometer 100 is based on components (110, 120, 130) that are connected by fiber connections 101, 102. In particular, the fiber interferometer 100 in the present embodiment has a first mirror component 110, a second mirror component 120 and a beam splitter component 130, wherein the beam splitter component 130 is connected to the first mirror component 110 via a first fiber connection 101 of a first length and to the second mirror component 120 via a second fiber connection 102 of a second length.

The fiber interferometer 100 comprises a fiber tensioning device 140 with a winding body around which the at least one fiber connection, namely the second fiber connection 102, is wound. The second fiber connection 102 is wound around the fiber tensioning device 140 as shown in FIG. 3. With the fiber tensioning device 140, a static tension can be generated in the glass fiber 102 fiber tensioning device and thus the OPL can be adjusted. For this purpose, the fiber tensioning device 140 comprises an adjustment device 145 configured to change a diameter of the winding body 143 and thus apply mechanical tension to the second fiber connection 102. The fiber tensioning device 140 can be part of a separate component.

The figure shows fiber connection points 107 in the first fiber connection 101 and the second fiber connection 102 where the individual components 110, 120, 130 were joined together.

The shown parts of the fiber interferometer 100 can be housed in a housing or temperature control housing with active temperature stabilization (not shown). This tempering device is configured to perform the tempering S140 of the second fiber connection 102 and advantageously also of the first fiber connection 101 by changing a temperature, so as to adjust the interferometer 100.

The features of the invention disclosed in the description, claims and figures can be essential for the realization of the invention both individually and in any combination.

### LIST OF REFERENCE SIGNS

10 pulse source
20 generation of entangled photon pairs
30, 40, 50 interferometer
31, 32, 41, 42 single photon detectors
100 fiber interferometer
101 first fiber connection
102 second fiber connection
107 fiber connection point
110 component (first mirror component)
120 component (second mirror component)
130 component (beam splitter component)
140 fiber tensioning device
143 winding body
144 opening
145 adjustment device
146 fiber
147 screw
150 component (with fiber with free end)
154 component housing
156 fiber
158 free end of fiber
210 clamping device
F1, F2, F3 forces
S110, S120, S130, S140 method steps

1. Method for the provision of a fiber interferometer, using components, wherein at least one component includes a light-guiding fiber with a free end, the method comprises manufacturing the fiber interferometer, with the following steps:
preparing, based on a mechanical cutting of the fiber with the free end, the components;
connecting, based on the cut fiber, the components through fiber connections; and
applying a static mechanical tension to at least one fiber connection, so as to approximate a length of the at least one fiber connection to a prescribed value and thus manufacture the fiber interferometer.

2. The method according to claim 1, wherein the method further comprises adjusting the interferometer.

3. The method according to claim 2, wherein the adjusting of the interferometer comprises tempering the at least one fiber connection, so as to further approximate the length to the prescribed value.

4. The method according to claim 3, wherein the adjusting of the interferometer takes place exclusively through the tempering.

5. The method according to claim 1, wherein the preparing comprises the following:
fixing the at least one component in a holding device;
pre-tensioning the fiber with the free end by application of a tensile force to the free end; and
clamping the fiber by a clamping device, thereby enabling the mechanical cutting of the fiber.

6. The method according to claim 5, wherein the fixing of the at least one component comprises any one of the following:
inserting a component housing into the holding device, and/or
clamping the fiber with the free end in a mounting fixture and
inserting the mounting fixture into the holding device.

7. The method according to claim 1, wherein the applying of the static mechanical tension is based on at least one of the following:
a mechanical fiber tensioning device,
an electromechanical fiber tensioning device, and
a piezoelectric fiber tensioning device.

8. The method according to claim 1, wherein the applying of the static mechanical tension is based on a fiber tensioning device which comprises the following:
a winding body configured to wind the at least one fiber connection around the winding body, and
an adjustment device configured to change a diameter of the winding body and thus apply the tension.

9. The method according to claim 3, wherein the fiber interferometer to be manufactured has a tempering device configured to perform the tempering based on the tempering device by changing a temperature.

10. The method according to claim 3, wherein the tempering comprises changing a temperature within a housing that encloses the at least one fiber connection.

11. The method according to claim 1, further comprising:
providing a reference interferometer; and
measuring the length of the at least one fiber connection based on a comparison with the reference interferometer.

12. The method according to claim 11, wherein the measuring is based on one of the following methods:
white light interferometry, and/or
optical coherence tomography.

13. A fiber interferometer manufactured from components that are connected by fiber connections the fiber interferometer comprises:
a fiber tensioning device with a winding body around which at least one fiber connection is wound, and with an adjustment device configured to change a diameter of the winding body and thus apply mechanical tension to the at least one fiber connection; and
a tempering device configured to perform tempering of the fiber connections by changing a temperature, so as to adjust the interferometer.
